(19) United States
(12) Patent Application Publication
(10) Pub. No.: US 2010/0013996 A1
(43) Pub. Date: Jan. 21, 2010

(54) METHOD AND SYSTEM FOR THEME-BASED SETTINGS FOR A DISPLAY DEVICE

(75) Inventors: Byung Chan Kang, Downey, CA (US); Sun Ahn, Ladera Ranch, CA (US)

Correspondence Address: Myers Andras Sherman LLP, 19900 MacArthur Blvd., Suite 1150, Irvine, CA, 92612, US

(73) Assignee: Samsung Electronics Co., Ltd., Suwon City (KR)

(21) Appl. No.: 12/176,241

(22) Filed: Jul. 18, 2008

(51) Int. Cl. H04N 5/44

(52) U.S. Cl. 348/553; 348/E05.096

(57) ABSTRACT

A method and system for controlling settings for an electronic device, is provided. One implementation involves detecting access to audio/visual content using the device, identifying a theme associated with the content, retrieving a set of device settings associated with the identified theme, and dynamically applying the retrieved settings to the device during access to the content.

### FIELD OF THE INVENTION

The present invention relates generally to controlling display devices, and in particular, to controlling settings of display devices.

### BACKGROUND OF THE INVENTION

Conventional consumer electronics devices such as television sets (TV) or set-top boxes (STB), provide users with the ability to adjust settings such as picture quality, audio, screen size, closed captions (CC), V-Chip, etc. However, if a user desires to change any of these settings while watching different types of programs, the user is required to manually change the settings for each program by navigating a menu or manipulating a remote control. This inconvenience during viewing can occur frequently due to the great variety of programming.

### BRIEF SUMMARY OF THE INVENTION

The present invention provides a method and system for controlling settings for an electronic device. One embodiment involves detecting access to audio/visual content using the device, identifying a theme associated with the content, retrieving a set of device settings associated with the identified theme, and dynamically applying the retrieved settings to the device during access to the content.

Identifying a theme associated with the content may include determining a theme associated with the content based one metadata for the content. The metadata may comprise one or more of: Electronic Program Guide, Event Information Table and Event Text Table.

Another embodiment further involves receiving customized device settings for a set of themes from a user, wherein retrieving a set of device settings associated with the identified theme includes selecting device settings associated with the identified theme from the customized settings. Multiple themes may be determined based on metadata for different audio/visual content, and associating initial device setting for each theme. User adjustment may be made to one or more of the initial device settings for a theme to generate customized device settings for the theme. The electronic device may comprise a consumer electronics device, such as a display device.

These and other features, aspects and advantages of the present invention will become understood with reference to the following description, appended claims and accompanying figures.

### BRIEF DESCRIPTION OF THE DRAWINGS

FIG. 1 shows a functional block diagram of a system implementing a theme-based settings process according to an embodiment of the present invention.

FIGS. 2 and 3 show example menus allowing a user to customize device settings for each theme, according to an embodiment of the invention.

FIG. 4 shows a flowchart of a theme-based settings technique, according to an embodiment of the present invention.

### DETAILED DESCRIPTION OF THE INVENTION

The present invention provides a method and system for theme-based settings for an electronic device such as a display device. One embodiment for a television set (TV) involves an automated process of adjusting correct/desired device settings depending on the theme (type) of trhe content (program) being accessed by the user on an electronic device. The user is not required to navigate a menu or manipulate keys on a remote to laboriously, and repeatedly, adjust the device settings for various content.

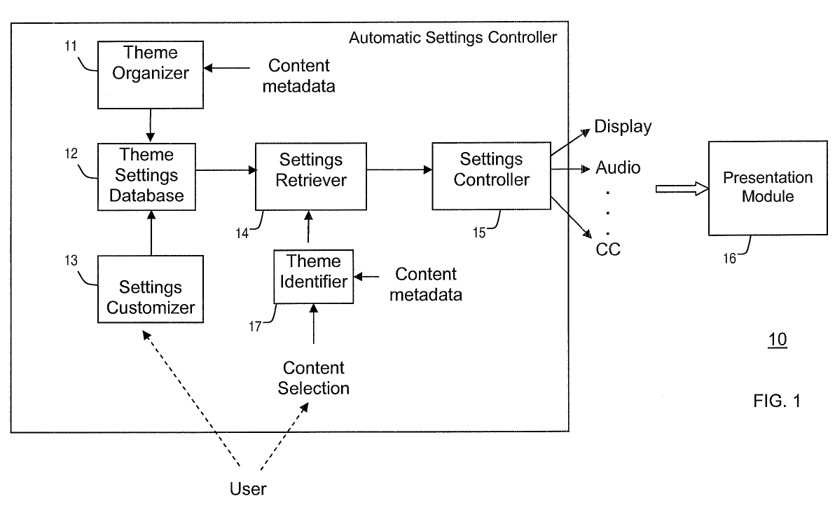

FIG. 1 shows a functional block diagram of a system 10 implementing an embodiment of the invention for an electronic device such as TV. A theme organizer 11 is configured to provide a set of themes which are then utilized for grouping content (programs) into themes. Each theme along with a corresponding set of device settings is placed in a theme settings data base 12. A settings customizer 13 is configured for enabling a user to customize the settings (e.g., picture, audio, screen size, closed captions, V-Chip) for each of one or more themes in the database 12 utilizing a user interface.

Thereafter, for content selected by the user, such as a new program (e.g., whenever a new program begins or whenever the user tunes to different channel), a theme identifier 17 detects the content selection. The identifier 17 then identifies the theme for the selected content (e.g., based on content metadata).

A settings retriever 14 then retrieves device settings for the determined theme from the database 12. The retrieved settings are provided to a settings controller 15 that adjusts the device settings for a presentation module 16 as necessary based on the retrieved settings. As such, for content selected by the user, the user is automatically provided with the particular settings previously customized for the theme of the selected content.

The presentation module 16 provides the selected content to the user according to the retrieved device settings. The presentation module 16 can comprise a display screen with audio devices, etc.

In one example, when the user tunes to a next TV channel, the theme for the current program on that channel is determined and checked against customized themes to determine if the user previously customized any specific setting of the display device for that theme. If so, then the settings of the display device are automatically (dynamically) changed based on the previous customization.

For example, the user can customize various settings for different themes as follows:
(1) User may want audio settings focused on speech for news programs but may want audio focused on live and full sound for movies.
(2) User may want V-chip settings to block unrated movie programs but may not want to block other unrated programs.
(3) User may want closed captions setting wherein closed captions are displayed for movies but may not closed captions for other types of programs.
(4) User may want bright picture settings for sports programs but not for other programs.

In one scenario for the above example, when the user switches from a movie to a news program, the live and full audio settings for the movie are automarically changed to audio focused on speech.

The theme grouping/organization can be based on existing and/or future programs. Adjustment of device settings is not limited to picture and audio (e.g., closed captions, V-Chip, screen size, etc., settings can be customized per theme).

User customization of device settings for any of the themes is possible. Settings are automatically adjusted during channel change based on theme of the ongoing program on each channel. User can customize/change the theme settings at any time. Existing program types may be grouped into themes. The invention automates the process of changing settings depending on theme.

For determining themes, in one implementation of the invention described hereinbelow, metadata for content may be used (e.g., electronic program guide (EPG)). The metadata may include information allowing grouping of present and future content into various themes. The EPG from a typical cable/satellite company for a set-top box may include themes such as “Sports,” “Movies,” “Talk Show,” “Music,” and “Adventure.” When a user wants to find a program of a desired theme, the user can check for the program theme in the EPG to narrow the available program selections.

Such existing metadata from cable/satellite signals, may be used according to the invention to group various programs into themes. Because the metadata is provided by the cable/satellite company, the electronic device (e.g., TV, STB) need not analyze program data for grouping the programs into themes. The electronic device may group the programs the way a cable/satellite set-top box would with the metadata.

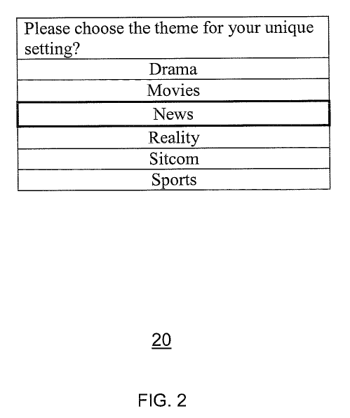

The user can then customize device settings for any of the themes. Initially, all the settings for each of the themes are defaulted to a standard setting. If the user desires to provide changes to any of the themes, the user can do so by accessing an example menu 20 in FIG. 2 wherein the user can select among themes, and modify settings for a selected theme using the settings customizer.

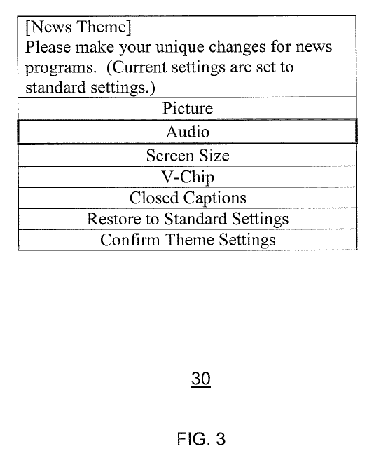

FIG. 3 shows an example menu 30 where the user selects “News” theme such that the user can adjust the settings for that theme in the settings database. The menu 30 provides the available settings which the user can customize for the News theme programs. In this example, the user wishes to make adjustments to sound settings wherein the user selects “Audio” settings in menu 30 for making such adjustments.

The user may, for example, modify the audio settings (e.g., using a graphic equalizer user interface) to focus the audio attributes for making sound frequencies in typical speech more prominent for a News program theme. The user may then make changes to other settings for the News program theme. Then the user may select “Confirm Theme Settings” to finalize all the setting changes for the selected theme. Or the user may select “Restore to Standard Settings” to the settings for the News theme back to standard settings.

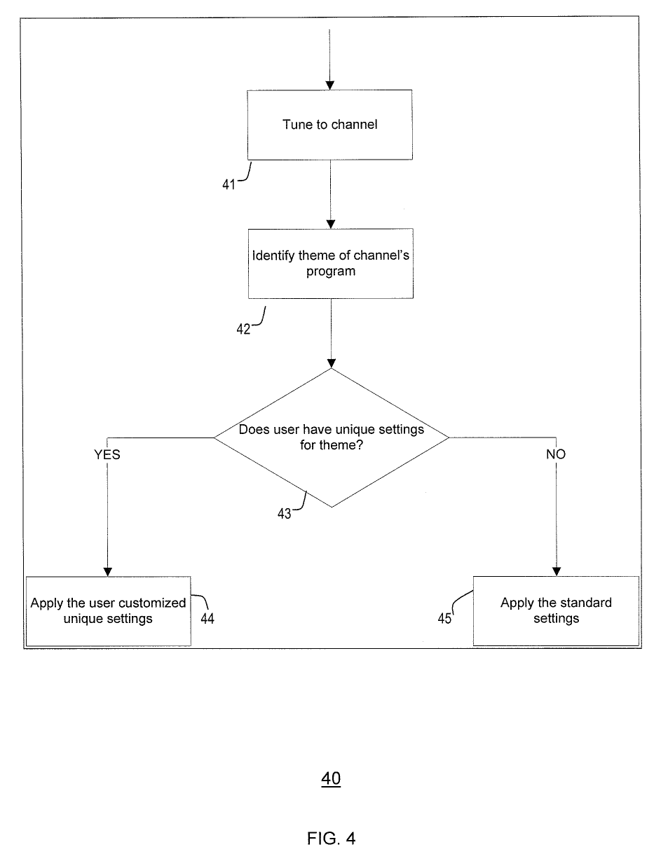

FIG. 4 shows a flowchart of a process 40 implementing an embodiment of a theme-based settings for an electronic device, according to the invention. The process 40 includes:
Block 41: User selects content (e.g., tunes to a TV channel).
Block 42: Identify the theme associated with the selected content (e.g., identify theme for the current program on the tuned channel).
Block 43: Determine if user-customized device setting for the identified theme exist. If yes, proceed to block 44, otherwise proceed to block 45.
Block 44: Apply user-customized settings to the electronic device for the selected content.
Block 45: Apply standard settings to the electronic device for the selected content.

The process 40 is repeated each time the user selects content for access via the electronic device.

In FIG. 1 the system 10 may comprise a TV which incorporates a dynamic theme-based settings process according to the invention. Or the presentation module 16 may be the TV. In another example, the dynamic theme-based settings process may be implemented on another device (e.g., STB) which may control the settings of the TV. Further, a dynamic theme-based settings process according to the invention may be implemented in other electronic devices that provide access to audio/visual content to users, such devices including consumer electronics devices and the like.

Further, using the theme group data provided by cable/satellite signals, additional themes can be determined by analyzing the content title and description, which can be found in the EIT (Event Information Table) and/or ETT (Event Text Table) of the PSIP (Program and System Information Protocol). In that case, keywords are detected in such EIT/ETT data to help determine the theme of selected content dynamically. Alternatively, the user can group content into themes. In one example, they user can manually identify channel numbers into themes in the database. Then, whenever the user tunes to a channel, the settings for the theme associated with the current program on that channel are retrieved and applied to the electronic device. This also allows creating and grouping themes for off-air signals as well.

As is known to those skilled in the art, the aforementioned example architectures described above, according to the present invention, can be implemented in many ways, such as program instructions for execution by a processor, as logic circuits, as an application specific integrated circuit, as firmware, etc. The present invention has been described in considerable detail with reference to certain preferred versions thereof; however, other versions are possible. Therefore, the spirit and scope of the appended claims should not be limited to the description of the preferred versions contained herein.

What is claimed is:

1. A method of controlling settings for an electronic device, comprising:
detecting access to audio/visual content using the device;
identifying a theme associated with the content;
retrieving a set of device settings associated with the identified theme; and
dynamically applying the retrieved settings to the device during access to the content.

2. The method of claim 1 wherein identifying a theme associated with the content further includes determining a theme associated with the content based one metadata for the content.

3. The method of claim 2 wherein the metadata comprises one or more of: Electronic Program Guide, Event Information Table and Event Text Table.

4. The method of claim 1 further comprising receiving customized device settings for a set of themes from a user, wherein retrieving a set of device settings associated with identified theme includes selecting device settings associated with the identified theme from the customized settings.

5. The method of claim 1 further including obtaining multiple themes based on metadata for different audio/visual content, and associating initial device setting for each theme.

6. The method of claim 5 further comprising receiving user adjustment to one or more of the initial device settings for a theme to generate customized device settings for the theme.

7. The method of claim 1 wherein the electronic device comprises a consumer electronics device.

8. An apparatus for controlling settings for an electronic device, comprising:
an identifier module configured for detecting access to audio/visual content using the device and identifying a theme associated with the content;
a settings retriever configured for retrieving a set of device settings associated with the identified theme; and
a settings controller configured for dynamically applying the retrieved settings for the device during access to the content.

9. The apparatus of claim 8 wherein the identifier module is further configured for identifying a theme associated with the content based one metadata for the content.

10. The apparatus of claim 9 wherein the metadata comprises one or more of: Electronic Program Guide, Event Information Table and Event Text Table.

11. The apparatus of claim 8 further comprising a customizer configured for receiving customized device settings for a set of themes from a user, wherein the retriever retrieves a set of device settings associated with identified theme from the customized settings.

12. The apparatus of claim 8 further comprising a theme organizer configured for obtaining multiple themes based on metadata for different audio/visual content, and associating initial device setting for each theme.

13. The apparatus of claim 12 further comprising a customizer configured for receiving user adjustment to one or more of the initial device settings for a theme to generate customized device settings for the theme.

14. The apparatus of claim 8 wherein the electronic device comprises a consumer electronics device.

15. A system, comprising:
an electronic device for access to audio/visual content;
an automatic settings controller comprising:
an identifier module configured for detecting access to audio/visual content using the device and identifying a theme associated with the content;
a settings retriever configured for retrieving a set of device settings associated with the identified theme; and
a settings controller configured for dynamically applying the retrieved settings for the device during access to the content.

16. The system of claim 15 wherein the identifier module is further configured for identifying a theme associated with the content based one metadata for the content.

17. The system of claim 16 wherein the metadata comprises one or more of: Electronic Program Guide, Event information Table and Event Text Table.

18. The system of claim 15 further comprising a customizer configured for receiving customized device settings for a set of themes from a user, wherein the retriever retrieves a set of device settings associated with identified theme from the customized settings.

19. The system of claim 15 further comprising a theme organizer configured for obtaining multiple themes based on metadata for different audio/visual content, and associating initial device setting for each theme.

20. The system of claim 19 further comprising a customizer configured for receiving user adjustment to one or more of the initial device settings for a theme to generate customized device settings for the theme.

21. The system of claim 15 wherein the electronic device comprises a consumer electronics device.
